(19) United States
(12) Patent Application Publication
(10) Pub. No.: US 2003/0204476 A1
(43) Pub. Date: Oct. 30, 2003

(54) Accounting process server, key output program, and terminal

(75) Inventors: Tomokazu Murakami, Tokyo (JP); Junichi Kimura, Koganei (JP); Masahiro Kageyama, Hino (JP); Hisao Tanabe, Hachioji (JP); Nobuhiro Sekimoto, Kokubunji (JP)

Correspondence Address: Stanley P. Fisher, Reed Smith LLP, 3110 Fairview Park Drive, Suite 1400, Falls Church, VA, 22042-4503, US

(73) Assignee: Hitachi, Ltd.

(21) Appl. No.: 10/372,339

(22) Filed: Feb. 25, 2003

(30) Foreign Application Priority Data
Apr. 24, 2002 (JP) 2002-121630

(51) Int. Cl. G06F 17/60; H04K 1/00

(52) U.S. Cl. 705/71

(57) ABSTRACT

In a system using a terminal not connectable to a network during playback, when a user freely selects and reproduces encrypted contents, in the existing method, the initial load on the user is large and charging cannot be assured. Time counting is started when a user downloads a key generation program and accounting is performed automatically unless reset within a predetermined period of time or accounting is performed upon downloading and pay back is performed when reset within a predetermined period of time. Thus, it is possible to provide a method offering a large degree of freedom for a user and assuring accounting for a content provider.

### BACKGROUND OF THE INVENTION

1. Field of the Invention

The present invention relates to an accounting process method for performing management of a content, a server for performing an accounting process, and a terminal apparatus for reproducing the content.

2. Description of the Related Art

In general, contents such as music, video, and a game are delivered to a user in a form of package medium such as a CD (compact disc) and a DVD (digital versatile disc) or by using a network such as the Internet or using a satellite broadcast. The contents have information significantly compressed by using the video compression technique such as the MPEG-2 (Motion Picture Expert Group) and the MPEG-4 and the audio compression technique such as the MP3 (MPEG-1 Audio Layer 3). It is possible to record a large amount of content on a package medium having a predetermined storage capacity and it is possible to effectively transmit a content by using a transmission path having a predetermined band width.

Moreover, these contents are subjected encryption using the CSS (Content Scrambling System) and copy management method such as SCMS (Serial Copy Management System) so as to protect copyrights and prevent unauthorized copying. For example, in the case of CSS, a content such as a movie is encrypted and recorded on the DVD, so that playback cannot be performed unless a licensed encryption release key is used. In the case of SCMS, the number of copying is limited when music software is copied from a CD to an MD (mini disc). When a user utilizes a content encrypted by scrambling or the like, the user utilizes the encryption release key the terminal has in advance or acquires an encryption release key from a server by using an IC card or online authentication.

A so-called ultra-distribution is now spreading as a distribution method of the contents thus protected for copyrights. In this method, a large amount of encrypted contents are delivered in the form of package media, via the satellite broadcast or the Internet. A user selects a desired content among the delivered contents, performs a viewing request to the server, and pays consideration by the accounting process so as to acquire the encryption release key for viewing. In this method, the accounting process performed for the user request is important. A representative accounting process is a pay-first method. That is, the user performs a viewing request to the server and performs the accounting process when downloading the content encryption release key. Moreover, a pay-later method is also used. That is, the accounting process is not performed when downloading the encryption release key and the accounting process is performed when the user reports a playback history to the server after the playback of the content. These accounting processes are selected according to the user viewing format and the terminal function. In the terminal always capable of accessing the network, the pay-first method is widely used for performing the accounting process when requesting for viewing. Moreover, in the environment where the user is sure to access the server after the viewing, the pay-later method is used so as to increase the user's comfort.

In the contents distribution system such as the ultra-distribution method, when a mobile terminal which cannot be connected to the Network is used when utilizing the content, the aforementioned accounting method cannot realize the proper accounting process.

In the contents distribution system of the ultra-distribution method, a user mobile terminal contains a plenty of encrypted contents and the user selects some of them and requests for viewing to the server to acquire an encryption release key. There is a problem of the accounting process in a system using a mobile terminal which itself has no network connection function, for example, a mobile terminal connectable to the network at home but not connectable while carrying it.

For example, in the pay-first method, the accounting process is performed when downloading the encryption release key. Accordingly, in order to utilize any of the contents stored in the terminal while a user is carrying the terminal, it is necessary to purchase the encryption release keys of all the contents in advance at home. Thus, when the pay-first method is used in the mobile terminal not connectable to the network, it is necessary to perform accounting processes for all the contents although only some of the contents are actually used. That is, this causes a significantly large load to the user.

On the other hand, in the pay-later method, the accounting process is performed when a user reports to the server a playback history after viewing and the user need not perform an excessive accounting in advance. However, in this method, the accounting process cannot be performed if the user does not report the playback to the server. That is, the contents provider has a risk that no fee can be gotten for the contents.

Thus, the existing accounting system is not appropriate as the accounting method in a terminal not connectable to the network during playback. A new accounting system has been desired so that a user can freely decide a content to be reproduced and the content provider can perform accounting process without fail.

### SUMMARY OF THE INVENTION

It is therefore an object of the present invention to provide an accounting method capable of offering a large degree of freedom for a user to select a content and surely performing an accounting process by using a time counting in the server and key information indicating whether the user has reproduced a content.

In order to achieve the aforementioned object, the outline of the present invention disclosed in this application is an accounting process server including a network interface, a database storing a content, and a controller. The controller receives a content ID and a user ID via the interface and outputs via the interface a content corresponding to the content ID and stored in the database and a key output program for outputting a decode key or reset key for reproducing the content or encrypted data where the decode key and the reset key are encrypted. Simultaneously with this, the controller starts time counting for an accounting process for the user account specified by the user ID. The controller cancels the accounting process for the user account if the reset key is received via the interface within a predetermined time after the time counting is started and performs the accounting process for the user account if the reset key is not received.

Furthermore, the present invention provides a key output program corresponding to a content executed in a terminal including an input device, a storage device for storing a content, and a decoder. The program causes the terminal to execute a step for outputting a decode key enabling decoding of the content stored in the storage device by the decoder upon reception of a content playback instruction via the input device, a step for outputting a reset key upon reception of a content playback reject instruction via the input device, and a step for storing the decode key and the reset key in the storage device.

Other objects, features and advantages of the invention will become apparent from the following description of the embodiments of the invention taken in conjunction with the accompanying drawings.

### BRIEF DESCRIPTION OF THE DRAWINGS

FIG. 1 is an accounting method according to an embodiment of the present invention.

FIG. 2 is an accounting method according to another embodiment of the present invention.

FIG. 3 is an accounting method according to still another embodiment of the present invention.

FIG. 4 is an accounting method according to yet another embodiment of the present invention.

FIG. 5 illustrates a contents distribution system according to an embodiment of the present invention.

FIG. 6 illustrates a server configuration according to an embodiment of the present invention.

FIG. 7 illustrates a terminal configuration according to an embodiment of the present invention.

FIG. 8 illustrates a screen display according to an embodiment of the present invention.

### DETAILED DESCRIPTION OF THE EMBODIMENTS

Description will now be directed to embodiments of the present invention with reference to the attached drawings.

In order to explain an accounting method according to the present invention, there is given an example of a content distribution system in which a content provider distributes a content such as video, music, and a game to a user and the user pays the content fee to the content provider when using the content. Explanation will be given on a system in which a content is encrypted for protecting the copyright and distributed through a CD, DVD, the Internet, the satellite broadcast, and the like to a user terminal in advance and a user performs a viewing/listening request to a server when utilizing the content and performs an accounting process to acquire an encryption release key, thereby releasing the encryption and utilizing the content. It should be noted that the account process of the present invention is not to be limited to this. A content may not be delivered in advance but delivered together with an encryption release key when a viewing/listening request is made. A terminal for reproducing the content may be a mobile terminal or a stand-alone type including a PC (personal computer), a PDA (personal digital assistant), a cellular telephone, a game device, a satellite broadcast receiver, and a karaoke device. Moreover, the information such as an encryption release key may not be stored in the terminal device main body but in an IC (integrated circuit) card or the like. Communication between a server and the terminal may be performed by using an ordinary network including the Internet, telephone line, or the like.

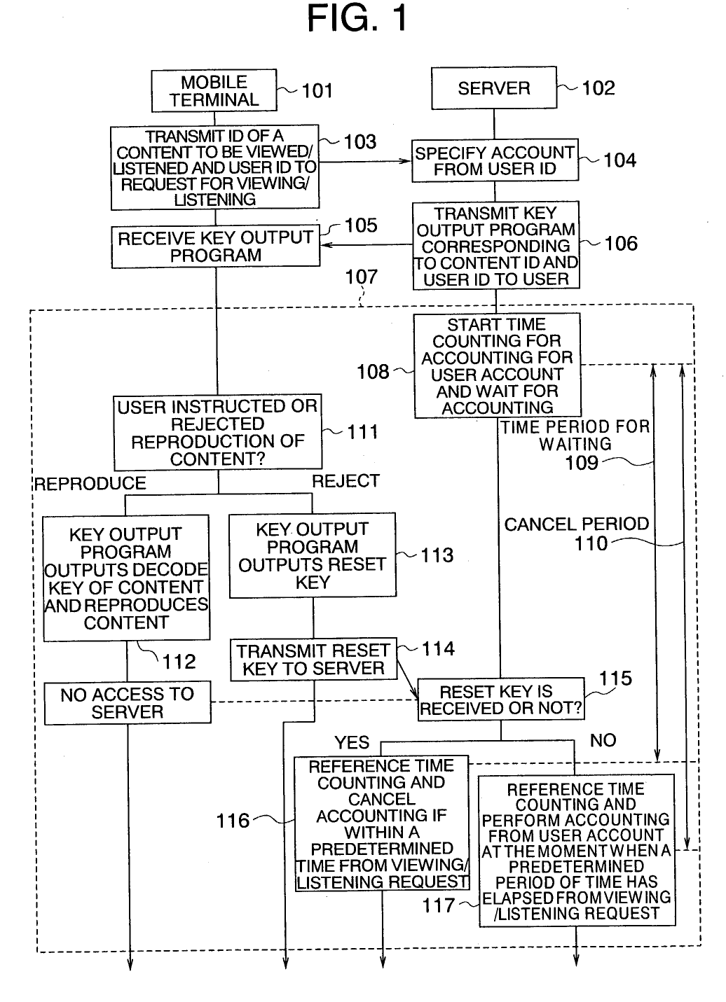

FIG. 1 illustrates an example of the accounting method according to the present invention.

Explanation will be given on the operation of a user mobile terminal (101) and a server (102) along the flow of processing. The mobile terminal (101) already contains a plenty of encrypted contents, which are under management by content ID. It is assumed that in the server, a user ID for specifying the user and user account information for performing the accounting process are registered.

Firstly, in step (103), the user transmits a content ID of the content to be used and the user ID to the server to request for viewing/listening. In response to this, in step (104), the server receives the viewing/listening request from the user and searches the server database according to the user ID to specify the user account information registered for performing the accounting. Subsequently, in step (106), the server generates a key output program corresponding to the content ID and the user ID and transmits it to the user. In response to this, the mobile terminal receives the key output program in step (105). After performing the processing of step (106), the server immediately starts an accounting step (107) and proceeds to step (108). When the user wants to use a plurality of contents, the user repeats the operations of step (103) to step (105) on the mobile terminal. For example, it is assumed that a plurality of music contents are recorded on the mobile terminal and the user listens to favorite music compositions while carrying the mobile terminal. In this case, while at home, the mobile terminal is connected to the network adapter, the music contents are recorded, and the key output program corresponding to the contents is downloaded by the aforementioned steps.

Here, the key output program is a program operating on the mobile terminal. When a user wants to instruct playback of a content, a decode key is output to release encryption of the encrypted content and the content is reproduced, and when the user rejects playback of the content, a reset key is output. The key output program itself is protected from decoding and held in a memory area which cannot be altered by the mobile terminal user. The key output program outputs only one of the decode key and the reset key according to the user instruction. For example, a cellular telephone, a satellite broadcast receiver, an IC card and the like have a memory area that cannot be altered by the user and a broadcast organization, a communication organization, or a user can download a program to operate there. The key output program is stored and operated in such a memory area. Moreover, the key output program is uniquely generated for one viewing/listening request made by the user for a particular content and controlled to output only the decode key or the reset key according to the user instruction for playback or rejection.

Moreover, the program actually performing the processing may be held as software or hardware by the terminal and download encrypted data of the decode key and the reset key from the server, so that terminal program releases the encryption of the encrypted data and outputs the key. The key output program can be realized by a secure program and encrypted data of key information such as the decode key and the reset key. For example, a key output program including only a secure program is recorded on an IC card in advance and distributed to the user terminal, so that the encrypted data is downloaded and the key is output upon viewing/listening request. Hereinafter, explanation will be given on an example of the key output program in which the secure program is integrated with the encrypted data.

The decode key is a key for releasing encryption of the content corresponding to the content ID transmitted from the user. The reset key is a key used for canceling the wait for accounting in the server. The decode key and the reset key are protected from decoding and managed according to the content ID, the user ID, the time when the user accesses the server, and the like. For these keys, an encrypted data string can be used.

The number of playback times of the content may be managed by the meta data belonging to the content or by the decode key. When using the management method by the meta data, a decoder performs playback of the content according to the meta data belonging to the content. The key output program outputs only one decode key to the content and rewrites the meta data when necessary, thereby controlling the number of playback times. The meta data cannot be altered by the user. On the other hand, when using the management method by the decode key, the decoder reproduces the content only once for the decode key. Using the playback start time and the playback count as variables, the key output program creates a plurality of decode keys for allowing the number of playback times of the content. Hereinafter, for simplicity, explanation will be given on a case that the number of playback times of the content is not limited after output of the decode key. In this case, the key output program outputs only one decode key for the content and the decoder can reproduce the content repeatedly by using the decode key.

Hereinafter, explanation will be given on the accounting process step (107) which is started at step (108).

In step (108), the server starts counting the time for accounting for the user account and waits for accounting. At this moment, no accounting is performed, and wait mode is set in after specifying the account. Here, the server waits for reception of the reset key from the mobile terminal and waits until a predetermined cancel period (110) has elapsed by time counting. The cancel period (110) may be, for example, one day or one week which can be decided according to the system. For the time counting, the start time is recorded as data and the time can be compared to the cancel period (110) at a predetermined time interval.

On the other hand, after reception of the key program in step (105), the mobile terminal can be disconnected from the network and carried about. The user can reproduce the content by the content key and the key output program held in the mobile terminal when the user wants. Here, in step (111), the user may reproduce the content or reject playback of the content. When the user instructs playback of the content, control is passed to step (112) and when the user rejects playback of the content, control is passed to step (113).

In step (112), the key output program outputs a decode key of the content and releases encryption of the encrypted content for playback. In this case, the user need not access the server because accounting for the specified account is automatically performed as consideration for the content playback after a predetermined cancel period (110).

In step (113), the key output program outputs a reset key. The reset key is a key indicating that the user has not reproduced the content but rejected. In this case, the user accesses the server within a predetermined cancel period (110) and transmits the reset key to verify that the content has not been reproduced, thereby evading the accounting. At the moment when the network access is enabled within the cancel period (110), in step (114), the user transmits the reset key to the server. Even when the user has a plenty of contents and key output programs, no accounting is performed if the user transmits the reset key within a predetermined cancel period (110). Accordingly, the user can download the key output program if the user has not yet decided to use the content while carrying. Thus, the user can select and use a favorite one among a plenty of contents when the user wants.

The server performs time counting while waiting for reception of the reset key in step (108) and after. Here, in step (115), it is decided whether the reset key is received within a predetermined cancel period (110). When the reset key is received, control is passed to step (116) and when not received, control is passed to step (117).

In step (116), at the moment when the reset key is returned, the wait time (109) from the viewing/listening request time to the reception time is referenced. If the wait time is within the predetermined cancel period (110), accounting for the content specified by the user is cancelled and the accounting wait state is terminated. Thus, the user need not perform accounting for the content not reproduced. Moreover, when the wait time (109) exceeds the predetermined cancel period (110), a predetermined cash back may be performed to the user account.

In step (117), if the predetermined cancel period (110) has passed without receiving the reset key from the user, accounting is performed from the user account as consideration for the specified content playback. The case that the reset key is not received may be when the user has reproduced the content or has not reproduced the content but not transmitted the reset key. In these cases, accounting is performed. When the reset key is received after the cancel period (110) has passed, a predetermined cache back may be performed.

Accounting process is performed as has been described above. By this method, the user can perform the accounting process after viewing/listening a content even on a terminal not connectable to the network in the mobile environment and a content provider can surely perform the accounting process.

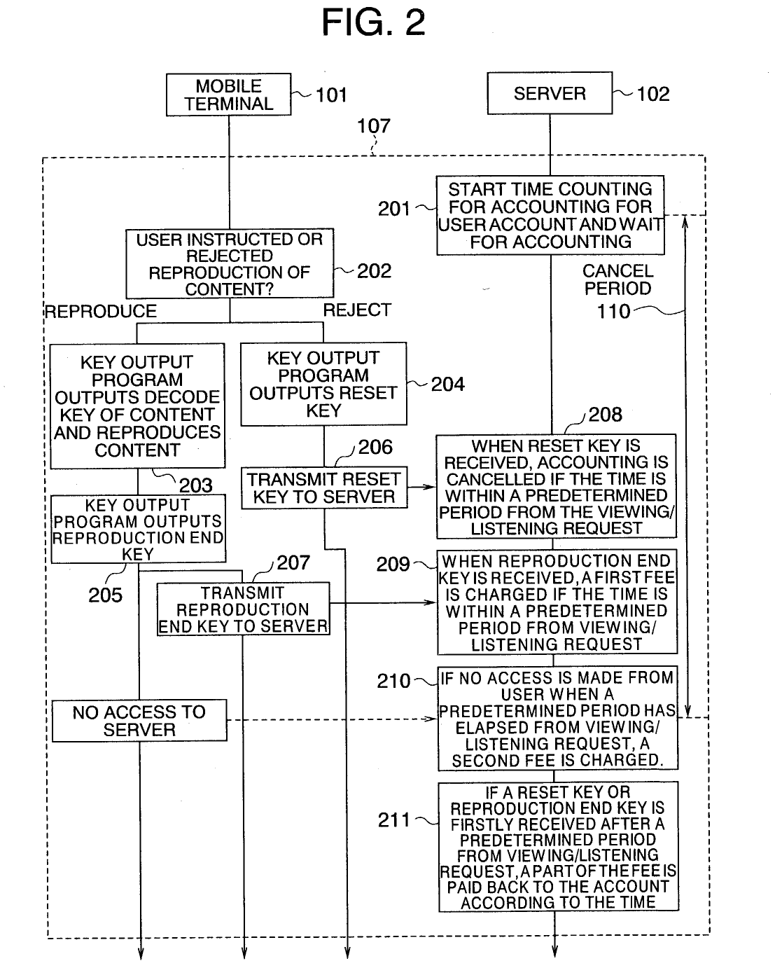

FIG. 2 shows another example of the accounting method according to the present invention.

FIG. 2 shows a detailed explanation of the other example of the accounting step (107) in FIG. 1.

In this example, when the user instructs playback of a content, the key output program outputs the decode key to reproduce the content and outputs the playback end key after the playback. On the other hand, when the user rejects playback of the content, the key output program outputs the reset key. The key output program never outputs the reset key together with another key. The playback end key indicates that the user has reproduced the content.

In step (201), the server starts time counting for the accounting of the user account and waits for the accounting. The server waits for reception of the reset key and the playback end key from the mobile terminal and waits until the predetermined cancel period (110) has elapsed by the time counting.

On the other hand, the mobile terminal is disconnected from the network and carried around. During this time, the user can reproduce a content held in the mobile terminal by using the key output program held in the mobile terminal. Here, in step (202), the user can reproduce the content or reject playback of the content. When the user instructs playback of the content, control is passed to step (203), and when the user rejects playback of the content, control is passed to step (204).

In step (203), the key output program outputs the decode key of the content and reproduces the content. Moreover, after the playback, control is passed to step (205), where the key output program outputs the playback end key. The playback end key indicates that the user has reproduced the content. For example, upon completion of playback of the content, it is possible to prompt the user to input a questionnaire and the playback end key is output only when the questionnaire is filled in. Alternatively, the playback end key may be output only when the advertisement and CM included in the content is viewed. The playback end key may include information on a questionnaire and user playback history. Here, the accounting process differs, depending on whether user transmits the playback end key to the server in step (207).

In step (204), the key output program outputs the reset key. In this case, the user accesses the server within the predetermined cancel period (110) and transmits the reset key, thereby evading the accounting. Thus, the user transmits the reset key in step (206).

The server waits for reception of the reset key and the playback end key in step (201) and after while counting the time. Here, different processes are performed depending on whether the reset key or the playback end key is received within the predetermined cancel period (110). When the reset key is received within the cancel period (110), control is passed to step (208) and when the playback end key is received, control is passed to step (209). When neither of the reset key and the playback key is received until the predetermined cancel period (110) has elapsed, control is passed to step (210). Furthermore, when the reset key or the playback end key is received after the predetermined cancel period (110) has elapsed, control is passed to step (211). Here, an example the cancel period (110) is given in which the reception deadline of the reset key and the reception deadline of the playback end key are identical. However, it is also possible to perform management for the reset key and playback end key having different reception deadlines.

In step (208), when the reset key is received, accounting for the content specified by the user is cancelled. Thus, the user can evade accounting for the content not reproduced.

In step (209), when the playback end key is received, a predetermined fee (first fee) is charged as consideration for the content reproduced by the user. When the user reproduced the content and has not transmitted the playback end key, a fee (second fee) is automatically charged when the cancel period has elapsed. However, for example, by setting the first fee cheaper than the second fee, the user willingly transmits the playback end key, thereby reducing the load on the server for waiting for accounting. Moreover, if the playback end key is output only when a questionnaire is filled or the advertisement and CM are viewed, it is possible to promote the questionnaire filling and CM viewing by the user.

In step (210), when the predetermined cancel period (110) has elapsed without receiving the reset key or the playback end key from the user, a predetermined fee (second fee) is drawn from the user account.

In step (211), when the reset key or the playback end key is received after the predetermined cancel period (110) has elapsed from the viewing/listening request, a predetermined cache back is performed to the user account for the case when the reset key is received and for the case when the playback end key is received.

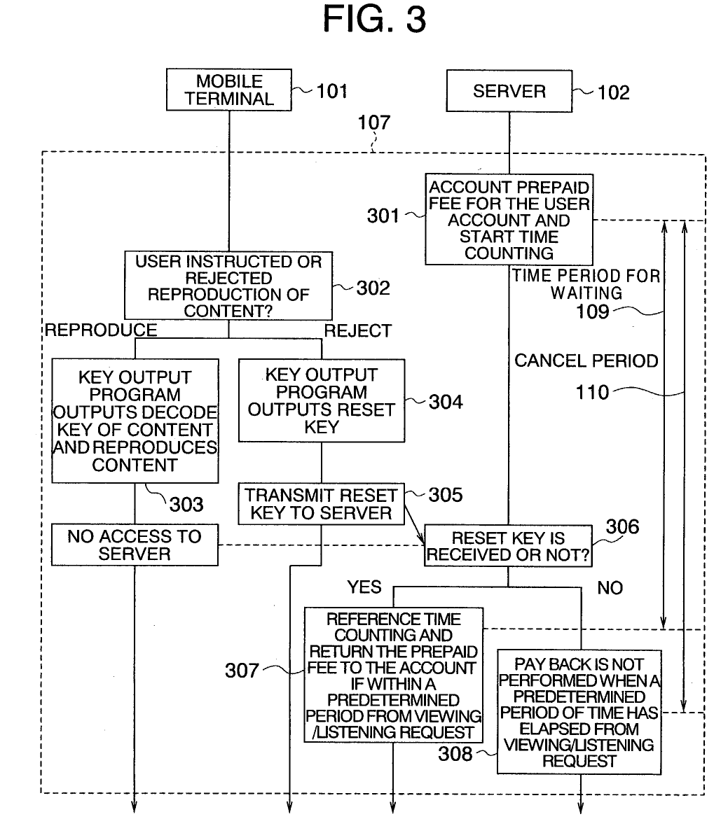

FIG. 3 shows still another example of the accounting method according to the present invention.

FIG. 3 gives a detailed explanation of accounting process step (107) shown in FIG. 1.

In step (301), the server accounts a prepaid fee for the user account as consideration of the playback of the content and starts time counting. The server waits for reception of the reset key from the mobile terminal and waits until the predetermined cancel period (110) has elapsed by time counting.

On the other hand, it is assumed that the mobile terminal is disconnected from the network and carried around. During this time, the user can reproduce a content held by the mobile terminal using the key output program. In step (302), the user may reproduce the content or reject playback of the content. When the user instructs playback of the content, control is passed to step (303) and when the user rejects playback of the content, control is passed to step (304).

In step (303), the key output program outputs the decode key of the content and reproduces the content. In this case, the user need not access the server because the accounting as consideration for the content playback has been performed already.

In step (304), the key output program outputs the reset key. In this case, the user accesses the server within the predetermined cancel period (110) and transmits the reset key so as to receive a cash back of the prepaid fee. For this, in step (305), the user transmits the reset key.

The server waits for reception of the reset key in step (301) and after and performs time counting. Here, in step (306), the reset key may be or may not be received within the predetermined cancel period (110). When the reset key is received within the cancel period (110), control is passed to (307), and when the predetermined cancel period (110) has elapsed without receiving the reset key, control is passed to step (308).

In step (307), at the moment when the reset key is received, accounting for the content specified by the user is cancelled and the prepaid fee is paid back to the user account. Thus, the user can get back the fee for the content not reproduced and the situation is identical when the user pays nothing for the content.

In step (308), when the predetermined cancel period (110) has elapsed without receiving the reset key from the user, the time counting and the wait for accounting are terminated. When the reset key is received after the cancel period (110) has elapsed, a certain cash back may be performed.

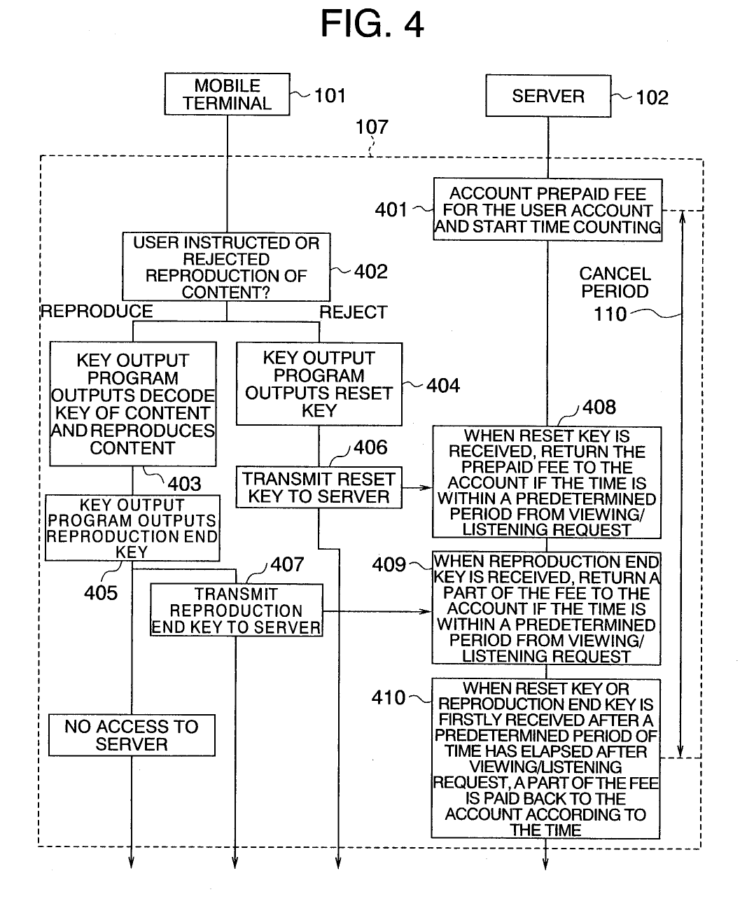

FIG. 4 shows yet another example of the accounting method according to the present invention.

FIG. 4 shows a detailed explanation of another example of the accounting process step (107) shown in FIG. 1.

In step (401), the server charges the a prepaid fee to the user account as consideration of the content playback and starts time counting. The server waits for reception of the reset key from the mobile terminal and waits until the predetermined cancel period (110) elapses by the time counting.

On the other hand, it is assumed that the mobile terminal is disconnected from the network and carried around. During this time, the user can reproduce a content held in the mobile terminal using the output program held in the mobile terminal. Here, in step (402), the user may reproduce the content or reject the playback of the content. When the user instructs the playback of the content, control is passed to step (403), and when the user rejects playback of the content, control is passed to step (404).

In step (403), the key output program outputs the decode key of the content and reproduces the content. Moreover, after the playback, control is passed to step (405), where the key output program outputs the playback end key. Here, the accounting process differs depending on whether the user transmits the playback end key to the server in step (407).

In step (404), the key output program outputs the reset key. In this case, the user accesses the server within the predetermined cancel period (110) and transmits the reset key if the user wants cash back of the prepaid fee. For this, the user transmits the reset key in step (406).

The server waits for reception of the reset key and the playback end key in step (401) and after while performing the time counting. Here, the reset key or the playback end key may be or may not received within the predetermined cancel period (110). When the reset key is received within the cancel period (110), control is passed to step (408) and when the playback end key is received, control is passed to step (409). When the reset key or the playback end key is received after the predetermined cancel period (110) has elapsed after the viewing/listening request, control is passed to step (410).

In step (408), at the moment when the reset key is received, the accounting for the content specified by the user is cancelled and the prepaid fee is paid back to the user account. Thus, the user can get back the fee for the content not reproduced and the situation is identical to the case when the user pays nothing.

In step (409), at the moment when the playback end key is received, a part of the prepaid fee is paid back to the user account. Since the user can get a certain cash back by transmitting the playback end key, if the playback end key is output only when a questionnaire is filled or the advertisement and CM are viewed, it is possible to promote the user to fill the questionnaire and view the CM.

In step (410), when the predetermined cancel period (110) has elapsed without receiving the reset key and the playback end key from the user, the timing counting and the wait for accounting are terminated. Moreover, a certain cash back is performed to the user account for each of the cases: when the reset key and the playback end key are received, or when the reset key is received, or when the playback end key is received after the cancel period (110) has elapsed.

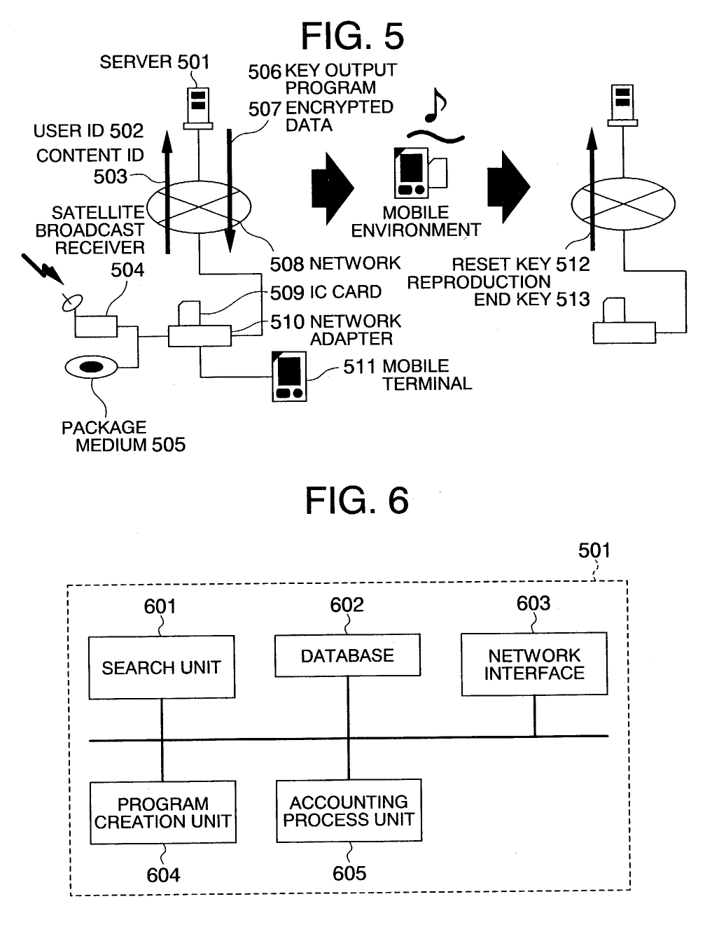

FIG. 5 shows an example of content distribution system according to the present invention.

By using the present invention, it is possible to realize a content distribution system in which accounting can be assured to be performed even when a user utilizes a content in a mobile environment not connectable to a network.

Firstly, a content provider encrypts a content for protecting copyright and distributes it through a CD, DVD, the Internet, the satellite broadcast, and the like to a user terminal. Each of the contents is controlled by a content ID (503) and has a decode key for releasing its encryption. A user receives such a content through the satellite broadcast receiver (504) or as a package medium (505) and stores it in a mobile terminal (511). It is also possible to transmit a content from a server (501) through a network (508) and a network adapter (510) to the mobile terminal (511).

Next, the user requests the server (501) for viewing/listening of a content which the user may use, at the moment in a connectable state to the network. By using the network adapter (510), the user accesses the server (501) via the network (508) and transmits the user ID (502) and the content ID (503). The user ID (502) and the content ID (503) are information for managing the user and the content and may be stored on an IC card (509) or the mobile terminal (511) at the user terminal side. According to the user ID (502) transmitted, the server (501) searches the user account registered for accounting and starts time counting. Moreover, using the user ID (506) and the content ID (503), the server creates a key output program (506) or encrypted data (507) corresponding to the user and the content and transmits it to the network adapter (510) of the user. The user stores this in the mobile terminal (511) or on the IC card (509) to be mounted on the mobile terminal. The key output program (506) is a program for outputting a decode key and a playback end key or a reset key according to a user instruction. The key output program (506) may be stored in the mobile terminal (511) or the IC card (509) in advance or may be downloaded. The encrypted data is data on the decode key, the playback end key, and the reset key which have been encrypted and outputs the decode key and the playback end key or the reset key according to the key output program (506). Here, explanation is given on a case that the IC card (509) is disconnected from the mobile terminal (511) but they may be integrated into a unitary block. The key output program (506) or the encrypted data (507) may be stored in the mobile terminal (511). Moreover, the network adapter (510) may be integrated with the mobile terminal (511) or the satellite broadcast receiver (504).

The user can utilize the content even in a mobile environment not connectable to the network, by using the content recorded on the mobile terminal (511), and the key output program (506) and the encrypted data (507) stored on the IC card (509). When the content is to be reproduced according to the user instruction, the key output program (506) outputs the decode key for releasing the encryption and outputs the playback end key (511) when the content playback is complete. When the user rejects playback of the content, the key output program (506) outputs the reset key (510). The key output program consists of a secure program and encrypted data (507) which cannot be altered by the user. It is possible to record the key output program (506) consisting of only the secure program on the IC card (509) in advance and download the encrypted data (507) when requesting for viewing/listening the content or it is also possible to download the key output program (506) having the both when requesting for viewing/listening the content. The key which has been output may be recorded in the mobile terminal (511) or on the IC card (509).

After this, if any content has not been actually reproduced although requested for viewing/listening, the user again accesses the server (501) via the network (508) within a predetermined cancel period. In this case, the user transmits the reset key (512) or the playback end key (513) to the server (501). The server (501) performs processing according to the key received and the time counted. For example, among the contents which have been requested for viewing/listening, no accounting is performed for those contents for which the corresponding reset keys have been transmitted within the cancel period. For the content for which the playback end key is transmitted, a reduced rate is applied for accounting. If no access is made after the cancel period has elapsed, normal rate is charged.

Thus, by using the present invention, it is possible to realize a reliable accounting method corresponding to the mobile environment. As an actual example, during overseas business trip, it is possible to carry around a mobile terminal containing movie contents so that a user can view a movie when the user wants. It is assumed that it is unknown when an empty time can be got and a movie is viewed during the empty time. The user records several movie contents before the business trip and accesses the server to download the key output programs of the respective contents. During the overseas business trip, even when the mobile terminal cannot be connected to the network, it is possible to view a favorite movie by using the key output program. For those contents that could not be viewed due to lack of time, the user can instruct rejection of playback for the key output program so as to obtain the reset key. After returning to the home country, for the contents not used, the user transmits the corresponding reset keys to the server within the cancel period. Thus, accounting is performed only for the contents which have been reproduced and no accounting is performed for those which have not been reproduced. When the user cannot access within the cancel period, accounting is performed all the contents whose key output programs have been downloaded. Thus, the content provider has no danger of missing the charge. By applying a reduced fee when the key output program outputs the playback end key after the content playback is complete, a questionnaire is filled, or a CM is viewed and the server has received the playback end key, it is possible to promote a user to utilize a content for a short period of time, to fill the questionnaire, and view the CM.

This method is a pay-later type as compared to the pay-first type when accounting is performed at the moment when a decode key is downloaded and there is a merit that the initial load for a user is reduced. As compared to the pay-later type in which accounting is performed by user application-after playback, the cancel period is set for automatically performing the accounting and there is a merit that a content provider has no danger of missing the charge.

FIG. 6 shows an example of the server configuration used in the present invention. This shows the server (501) of FIG. 5 in detail.

The server (501) includes a search unit (601), a database (602), a network interface (603), a program creation unit (604), and an accounting unit (605).

The search unit (601) compares the content ID and the user ID received from the user with the data on the database (602) and searches and acquires corresponding content information and user information.

The database (602) holds information such as content information and user information. The content information includes a content type and content, a content ID, a decode key, and the like. The user information includes a user name, account information for accounting, a user ID, access state to the server, key output program download time, and other management information.

The network interface (603) is connected to the network and transmits/receives a content ID, a user ID, a key output program, and other information to/from a terminal according to the instruction of the search unit (601), the program creation unit (604), and the accounting unit (605).

The program creation unit (604) creates a key output program or encrypted data corresponding to the a user and a content using the content decode key and the user access information acquired by the search unit (601) and transmits it to the user terminal. For example, it is assumed that a terminal secret key is held in a memory area of the user terminal which cannot be altered by the user and a terminal public key is managed at the server, when a key output program consisting of a secure program and encrypted data is used. The program creation unit (604) firstly creates a reset key corresponding to the user and the content, encrypts it by the public key encryption method using the decode key and the terminal public key, thereby creating encrypted data. The secure program is downloaded together with the encrypted data into the memory area of the user terminal that cannot be altered. When the user instructs playback, the content is reproduced by outputting the decode key by using the terminal secret key. When the user rejects the playback, the terminal secret key is used to output the reset key. The secure program deletes the encrypted data so that other keys are output after the key output. When the secure program is held in the user terminal or on the IC card in advance, the program creation unit (604) creates only encrypted data and transmits it to the user terminal.

The accounting unit (605) performs management of time counting for each user and performs an accounting process for the account specified by a user. The accounting unit (605) draws a specified content fee from the account and pays back a predetermined price when cash back is required. The accounting unit may not be integrated with the other processing units and may be independent as a separate server. The account may be prepared by the server or an ordinary bank account or postal account. Settlement can also be performed using a credit card.

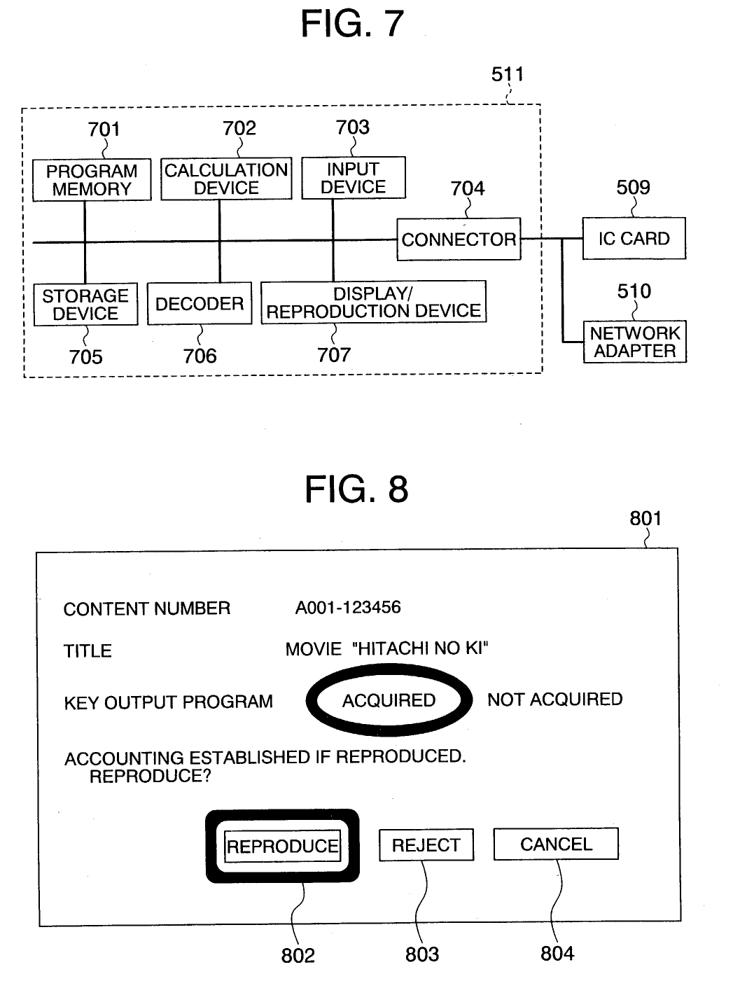

FIG. 7 shows an example of terminal configuration used in this invention. This shows configuration of a mobile terminal (511) of FIG. 5 in detail.

The mobile terminal (511) includes a program memory (701), a calculation device (702), an input device (703), a connector (704), a storage device (705), a decoder (706), and a display/playback device (707).

The program memory (701) is a memory area for holding a program such as a key output program. The program memory (701) has a secured memory area which cannot be altered by a user. It is possible to store an ordinary program such as a content decode in the program memory (701) and a program and data which require secrecy such as a key output program and encrypted data on an IC card (509) connected by the connector (704).

The calculation device (702) performs calculation according to the instruction from a program such as a key output program held on the program memory (701) or on the IC card (509) connected. For example, the calculation device (702) performs release of encryption of encrypted data and displays characters and images on the display/playback device (707).

The input device (703) is a device for a user to input an instruction through a button, a key, or a pen. Operation of the program stored in the program memory (701) is decided by the user input.

The connector (704) is an interface for connecting the mobile terminal (511) to the IC card (509) and network adapter (510). With this, the mobile terminal (511) transmits information such as the user ID and the content ID to the server and downloads the key output program. This is also used when connecting a satellite broadcast receiver (504) and a drive for reading a package medium (505) and recording a content into the mobile terminal (511). The mobile terminal (511) and the IC card (509), as well as the network adapter (510), the satellite broadcast receiver (504), a drive for reading the package medium (505) may be integrated into a unitary block.

The storage device (705) is a device for recording information such as a user ID and a content ID and a content. It is possible to use a disc medium such as a hard disc and a memory medium such as an IC.

The decoder (706) decodes a coded content and reproduces the content. For example, a content such as a movie coded by the MPEG-2 is reproduced as video and displayed on the display device (707). The decoder (706) may be mounted as software by the program memory (701) and the calculation device (702).

The display/playback device (707) displays a program state and reproduces/displays a content. For example, the data decoded by the decoder (706) is reproduced as video and audio and displays a screen prompting a user to select playback or rejection.

FIG. 8 shows an example of terminal screen display used in the present invention.

An example of the terminal display (801) shown is a screen prompting a user to select a content playback. The user holds an encrypted movie content on the terminal, already has requested for viewing/listening to the server and acquired the key output program. Here, if the user wants to reproduce the content, the user selects a playback button (802) and if the user rejects the content playback and cancels the accounting, the user selects the reject button (803). Moreover, if the user does not decide currently whether to reproduce the content, the user selects the cancel button (804). Here, when the user selects the playback button (802), the key output program outputs a decode key and reproduces the content. When the reject button (803) is selected, a reset key is output. When the cancel button (804) is selected, nothing is performed. The user cannot select both of the playback and rejection for the same content.

As has been described above, the accounting method for a content according to the present invention includes the following steps when a viewing/listening request is made by a user: a step for specifying a user and an account for performing accounting, a step for creating a program corresponding to the user and the content requested by the user and transmitting it to the user, a step for starting time counting for the user and wait for accounting, a step for waiting for reception of a key transmitted from the user, a step for performing a processing according a reception time of the key if the key is received, and a step for performing a processing according to whether the key is received after a predetermined period has elapsed after starting the wait for accounting.

Moreover, the accounting method for a content according to the present invention includes the following steps when a viewing/listening request is made by a user: a step for specifying a user and an account for performing accounting, a step for creating a program corresponding to the user and the content requested by the user and transmitting it to the user, a step of accounting a prepaid fee for the user account and starting time counting, a step for waiting for reception of a key transmitted from the user, a step for performing a processing according to a key reception time if the key is received, and a step for performing a processing whether the key is received when a predetermined period has elapsed after the start of waiting for accounting.

By using the accounting method of the present invention in the content distribution system, even when a terminal cannot be connected to a network upon playback, a user can select a favorite one from a plenty of contents and pay only for the contents reproduced while a content provider can surely charge the user.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An accounting process server comprising a network interface, a database for storing a content, and a control unit, wherein the control unit performs the functions of:
receiving a content ID and a user ID via the interface,
outputting a content corresponding to the content ID stored in the database, and a key output program for outputting a decode key for enabling the playback of the content or a reset key, or a encrypted data which is encrypted from the decode key and the reset key via the interface and starting time counting for the user account specified by the user ID,
cancelling an accounting for the user account if the reset key is received via the interface within a predetermined period of time from the time counting start, and
accounting for the user account if the reset key is not received.

2. An accounting process server comprising a network interface, a database for storing a content, and a control unit, wherein the control unit performs the functions of:
receiving a content ID and a user ID via the interface,
outputting a content corresponding to the content ID stored in the database, and a key output program for outputting a decode key for enabling the playback of the content or a reset key and outputting a playback end key upon detection of the playback end of the content, or an encrypted data which is encrypted from the decode key, the reset key, and the playback end key is output via the interface and starting time counting for the user account specified by the user ID,
charging a first fee for the user account via when the playback end key is received via the interface within a first period, and
charging a second fee for the user account if no access is made by the user within a second period which is longer than the first period.

3. An accounting process server as claimed in claim 2, wherein when the control unit has received the reset key or the playback end key via the interface after the second period, the control unit controls to perform accounting for the user account according the time when key was received.

4. An accounting process server comprising a network interface, a database for storing a content, and a control unit, wherein the control unit performs the functions of:
receiving a content ID and a user ID via the interface,
processing an accounting for a user account specified by the user ID and starts time counting,
outputting a key output program for outputting a decode key enabling playback of the content or a reset key, or a decode key and a reset key encrypted into encrypted data via the interface, and
controlling to pay back the fee for the user account when the reset key is received via the interface within a predetermined period of time from the time counting start.

5. An accounting process server comprising a network interface, a database for storing a content, and a control unit, wherein the control performs the functions of:
receiving a content ID and a user ID via the interface,
processing an accounting for a user account specified by the user ID and starts time counting,
outputting a key output program for outputting a decode key for enabling playback of the content or a reset key, and a playback end key upon detection of the playback end of the content after the decode key is output, or outputting a decode key, a reset key, and a playback end key encrypted into encrypted data via the interface,
controlling to pay back the fee for the user account when the reset key is received via the interface within a predetermined period of time from the time counting start, and
paying back a part of the fee for the user account when the playback end key is received via the interface within a first period of time.

6. An accounting process server as claimed in claim 5, wherein when the control unit receives the reset key or the playback end key via the interface after the predetermined period of time has elapsed, the control unit controls to pay back to the user account a fee corresponding to the time when the key was received.

7. A key output program corresponding to a content executed on a terminal comprising an input device, a storage device for storing a content, and a decoder, the program causing the terminal to execute steps of:
outputting a decode key enabling decoding of the content on the decoder,
outputting the reset key upon reception of a playback reject instruction for the content via the input device, and
storing the decode key and the reset key in the storage device.

8. A key output program as claimed in claim 7, the program causing the terminal to execute steps of:
outputting the playback end key upon detection of the playback end of the decoded content, and
storing the playback end key in the storage device.

9. A key output program as claimed in claim 7, wherein output of the decode key, the reset key, and the playback end key is performed by releasing the encryption of the keys.

10. A terminal for reproducing a content, comprising a program memory for storing a key generation program, wherein a decode key is output for reproducing a content when a user instructs playback of the content and a reset key is output when the user rejects playback of the content, and the terminal having a mechanism to output only one of the decode key and the reset key.

11. A key output program as claimed in claim 8, wherein output of the decode key, the reset key, and the playback end key is performed by releasing the encryption of the keys.
